(19) United States
(12) Patent Application Publication
(10) Pub. No.: US 2009/0023849 A1
(43) Pub. Date: Jan. 22, 2009

(54) INORGANO-NEUTRALIZED CALCINED KAOLINS FOR USE IN SILICONE RUBBER-BASED FORMULATIONS

(75) Inventors: Robert Bradshaw, Milledgeville, GA (US); Walter J. Polestak, Summit, NJ (US); Edward Sare, Macon, GA (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Imerys Kaolin, Inc., Dry Branch, GA (US)

(21) Appl. No.: 11/816,827

(22) PCT Filed: Oct. 5, 2005
(86) PCT No.: PCT/US05/35845

§ 371 Date: Apr. 6, 2008

Related U.S. Application Data
(60) Provisional application No. 60/654,989, filed on Feb. 22, 2005.

(51) Int. Cl. C08K 3/34; C04B 14/04

(52) U.S. Cl. 524/447; 106/486

(57) ABSTRACT

Disclosed herein are inorgano-neutralized calcined kaolin comprising calcined kaolin treated with at least one basic inorganic compound, a composition comprising the inorgano-neutralized calcined, and use of the inorgano-neutralized calcined kaolin in silicone rubber formulation. Further disclosed herein are a method of making the inorgano-neutralized calcined kaolin and a method of making a silicone rubber formulation comprising the inorgano-neutralized calcined kaolin.

This application claims priority to U.S. Provisional Patent Application No. 60/654,969, filed Feb. 23, 2005.

Disclosed herein is an improved, surface treated, calcined kaolin (“inorgano-neutralized calcined kaolin”) and the use thereof. Further disclosed herein are a composition comprising the inorgano-neutralized calcined kaolin and the use of the inorgano-neutralized calcined kaolin in silicone rubber formulations. Even further disclosed herein are a method of manufacturing the inorgano-neutralized calcined kaolin and a method of making a silicone rubber formulation comprising the inorgano-neutralized calcined kaolin.

In silicone rubber formulation, it is known to use silica fillers, such as crystalline silica, precipitated silica and fumed silica. However, use of the silica fillers can be costly and may raise concerns from a material hazard standpoint. Therefore, there is a need to find replacement or extension of the silica fillers without compromising the properties of the final silicone rubber product.

Calcined kaolin can be used as extending fillers in polymerization, such as in silicone rubber formulation. However, depending on, for example, the type of silicone polymer and/or the addition of specialty modifiers, calcined kaolin may not be used as the replacement and/or extending fillers, as they may retard or inhibit the curing process. In other words, calcined kaolin's usefulness and applicability may be limited due to its detrimental effects on the curing of, for example, the silicone rubber formulations.

Therefore, there remains a need for replacement and/or extension of the silica fillers using modified calcined kaolin, which can exhibit substantive levels of reinforcement, but do not inhibit the curing of silicone rubber formulations.

The present inventors have surprisingly found that treatment of the calcined kaolin with at least one basic inorganic compound can provide inorgano-neutralized calcined kaolin, which can satisfy at least one of the above-mentioned needs. The inorgano-neutralized calcined kaolin as disclosed herein can be used, for example, as a filler, a semi-reinforcing agent, and/or an extender for reinforcing agents, in polymerizing and cross-linking reactions using free-radical initiators. In one embodiment, the inorgano-neutralized calcined kaolin is used in silicone rubber formulations, such as in formulating heat-resisting silicone rubbers.

It has been found that the calcined kaolins that have poor curing responses also have highly acidic sites or centers on the surface, using the method of Benesi, as published in J. Am. Chem. Soc., vol. 78, pages 5490-5494. It is believed that a detrimental reaction can occur between the free-radical initiator in a polymer system and mineral fillers when acidic species, such as Lewis acids, ionically cleave the initiator, making the initiator inert. The resulting inert initiator fragments do not contain free radicals and therefore cannot start or propagate a radical chain reaction. For example, in a compounded silicone rubber system, the degree and efficiency of cross-linking reaction can be greatly affected by acid cleavage, which may prevent curing or lead to a poor curing with poor rubber-like properties.

The present inventors have surprisingly found that, by treating calcined kaolin with at least one basic inorganic compound, the surface acidities (Lewis acids) of the calcined kaolin can be reduced. Consequently, the performance of the inorgano-neutralized calcined kaolin can be improved in the curing process. The inorgano-neutralized calcined kaolin as disclosed herein can, for example, replace, as an extender, up to 50% of the precipitated silica used in silicone rubber formulations as a reinforcing agent.

Accordingly, one aspect of the present disclosure relates to an inorgano-neutralized calcined kaolin, comprising calcined kaolin treated with at least one basic inorganic compound.

Another aspect of the present disclosure provides a composition comprising an inorgano-neutralized calcined kaolin, wherein the inorgano-neutralized calcined kaolin comprises calcined kaolin treated with at least one basic inorganic compound.

As used herein, the term “inorgano-neutralized” means treatment with at least one basic inorganic compound so that the surface acidities (Lewis acids) of the calcined kaolin can be deactivated, i.e., reduction of the acid potential of the acid sites on the kaolin surface. The term “neutralized” does not necessarily mean that the pH value of the kaolin surface is at or near 7. The deactivation of the surface acidities of the calcined kaolin can be achieved by various mechanisms, such as a classical acid/base mechanism, binding of a molecule that stearically blocks the acid site, and other chemical modifications of the acid site.

As disclosed herein, the at least one basic inorganic compound can be chosen, for example, from ammonium oxalate, sodium carbonate, sodium hydroxide, and trisodium phosphate. In one embodiment, the at least one basic inorganic compound can be a basic inorganic compound other than ammonia.

As disclosed herein, the neutralizing treatment of calcined kaolin is performed, for example, in an ionizing medium, such as water. In one embodiment, the calcined kaolin is slurried using an aqueous medium, such as water, and is treated and well mixed with the at least one basic inorganic compound. In another embodiment, a dilute aqueous solution of the at least one basic inorganic compound is prepared and is misted or sprayed onto the calcined kaolin (misting or spraying approach). As disclosed herein, the misting approach also includes, for example, treatment performed in a fluidized bed. In another embodiment, the at least one inorganic compound and the calcined kaolin are added separately to a compounding masterbatch.

The degree of neutralization of the inorgano-neutralized calcined kaolin as disclosed herein can be determined using an absorbed Hammett indicator, such as a dicinnamalacetone/benzene (DCB) acidity indicator, which is widely used for determining the surface acidity of solids, such as catalysts. See Benesi, J. Am. Chem. Soc., vol. 78, pages 5490-5494.

The calcined kaolin as disclosed herein can have a median particle size ranging, for example, from about 0.5 μm to about 5.0 μm, such as from about 3.0 μm to 4.0 μm, and further such as about 3.5 μm. The median particle size of the calcined can be determined by, for example, a standard test procedure employing Stokes' Law of Sedimentation. For example, the median particle size of the calcined kaolin can be determined by measuring the sedimentation of the particulate product in a fully dispersed condition in a standard aqueous medium, such as water, using a SEDIGRAPH™ instrument, e.g., SEDIGRAPH 5100, obtained from Micromeritics Corporation, USA.

The inorgano-neutralized calcined kaolin as disclosed herein can be compounded into a polymer system, such as silicone rubber formulations, at much higher loadings without adversely affecting the curing process than those which are not inorgano-neutralized. In addition, the inorgano-neutralized calcined kaolin as disclosed herein, when compounded in a silicone rubber formulation, can provide similar mechanical properties to the resulting silicone rubber product as silica fillers widely used in the industry, and may even at a lower loading. For example, the mechanical properties of a silicone rubber compounded with 50 parts of the inorgano-neutralized calcined kaolin as disclosed herein can be comparable to the properties of silicone rubber compounded with 50-75 parts of US Silica's Min-U-Sil 5 (ca 1.0 μm average particle size), which is considered to be the premium natural silica extender and semi-reinforcing agent used in the silicone rubber industry.

Further disclosed herein are products comprising the inorgano-neutralized calcined kaolin as disclosed herein. These products are chosen, for example, from polymer products and silicone rubber products.

In one embodiment, the present disclosure provides a polymer product comprising an inorgano-neutralized calcined kaolin as disclosed herein, which can function as a filler, an extender, and/or a reinforcing agent. Depending on the particular polymer system and desired physical properties of the final polymer product, the inorgano-neutralized calcined kaolin can be present in a concentration ranging, for example, from about 1 to about 200 phr, such as from about 1 to about 100 phr, by weight of the final polymer product.

The polymer product disclosed herein comprises at least one polymer resin. The term “resin” means a polymeric material, either solid or liquid, prior to shaping into a plastic article. The at least one polymer resin used herein is one which, on curing, may form a plastic material. For example, the polymer product disclosed herein is chosen from cured polymers, such as free radical cured polymers and peroxide cured polymers. The polymers, which can be cured using peroxides as the crosslinker, include, for example, unsaturated polyesters, polyurethanes, polyethylenes, silicones, and elastomers. In one embodiment, the peroxides for unsaturated polyesters can be chosen, for example, from organic peroxides, such as diacyl peroxides (for example, decanoyl peroxide, lauroyl peroxide, and benzoyl peroxide); ketone peroxides (for example, 2,4-pentanedione peroxide); peroxyesters (for example, t-butyl peroxyneodecanoate, 2,5-dimethyl 2,5-di(2-ethylhexanoyl peroxy)hexane, t-amyl peroxy-2-ethyl-hexanoate, t-butyl peroxy-2-ethyl-hexanoate, t-amyl peroxyacetate, t-butyl peroxyacetate, and t-amyl perbenzoate); dialkyl peroxides (for example, dicumyl peroxide, 2,5-dimethyl-2,5-di-(t-butyl peroxy)hexane, bis(t-butyl peroxy)diisopropyl-benzene, di-t-amyl peroxide, di-t-butyl peroxide and 2,5-dimethyl-2,5-di-(t-butyl peroxy)hexyne-3); hydroperoxides (for example, cumene hydroperoxide); and peroxyketals (for example, 1,1-di-(t-butyl peroxy)-3,3,5-trimethyl-cyclohexane and 1,1-di-(t-butyl peroxy)-cyclohexane).

The at least one polymer resin, which can be used herein, can be chosen, for example, from polyolefin resins, polyamide resins, polyester resins, engineering polymers, allyl resins, and thermoset resins.

In another embodiment, the present disclosure provides a silicone rubber product comprising an inorgano-neutralized calcined kaolin as disclosed herein. The inorgano-neutralized calcined kaolin as disclosed herein can provide the benefits of resin extension, reinforcement of the rubber, and increased hardness of the rubber composition. In the silicone rubber product as disclosed herein, the inorgano-neutralized calcined kaolin is present in an amount ranging, for example, from about 1 to about 200 phr, such as from about 1 to about 100 phr, by weight of the rubber.

Further disclosed herein is a silicone rubber formulation, comprising
at least one filler comprising an inorgano-neutralized calcined kaolin, wherein the inorgano-neutralized calcined kaolin comprises calcined kaolin treated with at least one inorganic compound in an amount sufficient to reduce the activity of surface acid sites of the calcined kaolin; and
at least one silicone polymer.

Further disclosed herein is a method of manufacturing an inorgano-neutralized calcined kaolin, comprising treating a calcined kaolin with at least one basic inorganic compound. Such treatment can be in an ionizing medium. The ionizing medium can be chosen, for example, from aqueous media, such as water. Examples of the treatment include water spraying, misting, mixing, coating in a fluidized bed or paddle mixer, and treatment in a steam mill. The at least one basic inorganic compound is present in an amount of equal to or greater than 0.1%, by weight, ranging, for example, from about 0.1% to about 5.0%, such as from about 0.5% to about 2.5%, and further such as about 2.0% by weight of the calcined kaolin in the treatment.

In one embodiment, the treating operation comprises slurrying a calcined kaolin in water and mixing the resulting calcined kaolin with at least one basic inorganic compound. In addition, the method disclosed herein can further comprise drying, such as pan drying, spray drying, and drying in a fluidized bed dryer, and pulverizing the calcined kaolin treated with at least one basic inorganic compound.

Even further disclosed herein is a method of making a silicone rubber product, comprising adding into a silicone rubber formulation an inorgano-neutralized calcined kaolin, wherein the silicone rubber formulation comprises at least one silicone elastomer and at least one initiator and the inorgano-neutralized calcined kaolin comprises calcined kaolin treated with at least one basic inorganic compound. In addition, the silicone rubber formulation can further comprise at least one other filler, chosen, for example, from precipitated silica, crystalline silica, and fumed silica.

Further disclosed herein is a method of making a silicone rubber product, comprising adding into a silicone rubber formulation a calcined kaolin and at least one basic inorganic compound, wherein the silicone rubber formulation comprises at least one silicone elastomer and at least one initiator. In one embodiment, the calcined kaolin and at least one basic inorganic compound are added substantially simultaneously. In another embodiment, the calcined kaolin is added before the at least one basic inorganic compound. In yet another embodiment, the calcined kaolin may be added after the at least one basic inorganic compound. In addition, the silicone rubber formulation can further comprise at least one additional filler, chosen, for example, from precipitated silica, crystalline silica, and fumed silica.

All amounts, percentages, and ranges expressed herein are approximate.

The present invention is further illuminated by the following non-limiting examples, which are intended to be purely exemplary of the invention.

### EXAMPLES

### Example 1

A commercial calcined kaolin A with a median particle size of about 1.5 μm, a commercial calcined kaolin B with a median particle size of about 0.5 μm, and a commercial calcined kaolin C with a median particle size of about 1.5 μm treated with 2% by weight of ammonium oxalate separately relative to the weight of the calcined kaolin were used in comparison with a commercial fumed silica with a median particle size of about 1.0 μm in a silicone rubber formulation. Separately, samples of commercial calcined kaolins A, B, and C were slurried in water with a solid concentration of 35%, and then the slurry was stirred while the ammonium oxalate solution was added at a treatment level of 2% by weight relative to the weight of the calcined kaolin and allowed to react for approximately 1 hour. The mixture was then pan-dried at 70-90° C. and micropulverized three times. The silicone rubber formulation comprised 100 phr of SWS-725, 0.6 phr of Luperox 500 R (initiator), and various amount of fillers as shown below. 50 phr, 75 phr, and 100 phr of the commercial fumed silica were used as controls. 50 phr, 75 phr, and 100 phr of each commercial calcined kaolin A, B, or C treated with 2% by weight of ammonium oxalate relative to the weight of the calcined kaolin were used for the comparison. Compounding was performed in the laboratory using a standard 2-roll mill with no heat. The polymer was compression molded/cured at 340° F. and 1000 psi for 10 minutes. The physical properties of the resulting silicone rubbers were determined, including the Shore “A” Hardness, tensile at break, elongation at break and modulus at 100%, 200%, and 300%. The Shore “A” Hardness was measured according to ASTM D 2240 using a Type A durometer. The tensile at break and elongation at break were measured according to ASTM D 412 Method A. The modulus at 100%, 200%, and 300% were measured using an Instron 1120 device. The results are shown in Table 1.

TABLE 1

| | Control | | | 2% Ammonium Oxalate Treated Calcined Kaolin | | | | | | | | |
|---|---|---|---|---|---|---|---|---|---|---|---|---|
| | Commerical | | | Commercial Cal- | | | Commercial Cal- | | | Commercial Cal- | | |
| | Fumed Silica | | | cined Kaolin A | | | cined Kaolin B | | | cined Kaolin C | | |
| Amount (phr) | 50 | 75 | 100 | 50 | 75 | 100 | 50 | 75 | 100 | 50 | 75 | 100 |
| Shore “A” | 55 | 59 | 65 | 60 | 66 | 72 | 57 | 63 | 71 | 57 | 63 | 68 |
| Hardness | | | | | | | | | | | | |
| Tensile at | 760 | 715 | 680 | 680 | 610 | 560 | 770 | 690 | 605 | 695 | 590 | 510 |
| Break (psi) | | | | | | | | | | | | |
| Elongation at | 370 | 300 | 230 | 320 | 245 | 160 | 330 | 265 | 200 | 330 | 250 | 190 |
| Break (%) | | | | | | | | | | | | |
| Modulus | | | | | | | | | | | | |
| at 100% (psi) | 225 | 310 | 385 | 360 | 430 | 465 | 245 | 305 | 370 | 270 | 330 | 365 |
| at 200% (psi) | 495 | 595 | 655 | 575 | 585 | — | 530 | 580 | 605 | 520 | 545 | — |
| at 300% (psi) | 680 | 715 | — | 670 | — | — | 730 | — | — | 660 | — | — |

As shown in Table 1, with an increase of the loading level of the filler, such as the inventive fillers (i.e., 2% of ammonium oxalate treated commercial calcined kaolin A, B, and C), the shore “A” hardness and modulus of the final silicone rubbers increase. It is known in the art that modulus values indicate internal strength or ability to resist elongation.

In addition, as shown in Table 1, the shore “A” hardness and modulus of the final silicone rubbers compounded with the inventive fillers, i.e., 2% of ammonium oxalate treated commercial calcined kaolin A, B, and C, are superior to those compounded with the commercial fumed silica at each compounding level of 50 phr, 75 phr, or 100 phr. Therefore, the result indicates that the inorgano-neutralized calcined kaolin as disclosed herein can be used to replace the use of fumed silica fillers in silicone rubber formulation.

Unless otherwise indicated, all numbers expressing quantities used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. An inorgano-neutralized calcined kaolin, comprising calcined kaolin treated with at least one basic inorganic compound in an amount sufficient to reduce the activity of surface acid sites of the calcined kaolin.

2. The inorgano-neutralized calcined kaolin according to claim 1, wherein the at least one basic inorganic compound is chosen from ammonium oxalate, sodium carbonate, sodium hydroxide, and trisodium phosphate.

3. The inorgano-neutralized calcined kaolin according to claim 1, wherein the treatment is performed in an ionizing medium.

4. The inorgano-neutralized calcined kaolin according to claim 3, wherein the ionizing medium is water.

5. The inorgano-neutralized calcined kaolin according to claim 1, wherein the at least one basic inorganic compound is in an amount of equal to or greater than about 0.1% by weight of the calcined kaolin in the treatment.

6. The inorgano-neutralized calcined kaolin according to claim 5, wherein the at least one basic inorganic compound is in an amount ranging from about 0.1% to about 5.0% by weight of the calcined kaolin in the treatment.

7. The inorgano-neutralized calcined kaolin according to claim 6, wherein the at least one basic inorganic compound is in an amount ranging from about 0.5% to about 2.5% by weight of the calcined kaolin in the treatment.

8. The inorgano-neutralized calcined kaolin according to claim 7, wherein the at least one basic inorganic compound is in an amount of about 2.0% by weight of the calcined kaolin in the treatment.

9. A composition comprising an inorgano-neutralized calcined kaolin, wherein the inorgano-neutralized calcined kaolin comprises calcined kaolin treated with at least one inorganic compound in an amount sufficient to reduce the activity of surface acid sites of the calcined kaolin.

10. The composition according to claim 9, wherein the at least one basic inorganic compound is chosen from ammonium oxalate, sodium carbonate, sodium hydroxide, and trisodium phosphate.

11. The composition according to claim 9, wherein the at least one basic inorganic compound is in an amount of equal to or greater than about 0.1% by weight of the calcined kaolin in the treatment.

12. The composition according to claim 11, wherein the at least one basic inorganic compound is in an amount ranging from about 0.1% to about 5.0% by weight of the calcined kaolin in the treatment.

13. The composition according to claim 12, wherein the at least one basic inorganic compound is in an amount ranging from about 0.5% to about 2.5% by weight of the calcined kaolin in the treatment.

14. The composition according to claim 13, wherein the at least one basic inorganic compound is in an amount of about 2.0% by weight of the calcined kaolin in the treatment.

15. A product, comprising an inorgano-neutralized calcined kaolin, wherein the inorgano-neutralized calcined kaolin comprises calcined kaolin treated with at least one inorganic compound in an amount sufficient to reduce the activity of surface acid sites of the calcined kaolin.

16. The product according to claim 15, wherein the at least one basic inorganic compound is chosen from ammonium oxalate, sodium carbonate, sodium hydroxide, and trisodium phosphate.

17. The product according to claim 15, wherein the at least one basic inorganic compound is in an amount of equal to or greater than about 0.1% by weight of the calcined kaolin in the treatment.

18. The product according to claim 17, wherein the at least one basic inorganic compound is in an amount ranging from about 0.1% to about 5.0% by weight of the calcined kaolin in the treatment.

19. The product according to claim 18, wherein the at least one basic inorganic compound is in an amount ranging from about 0.5% to about 2.5% by weight of the calcined kaolin in the treatment.

20. The product according to claim 19, wherein the at least one basic inorganic compound is in an amount of about 2.0% by weight of the calcined kaolin in the treatment.

21. The product according to claim 15, wherein the inorgano-neutralized calcined kaolin is present in a concentration ranging from about 1 to about 200 phr in the product.

22. The product according to claim 21, wherein the inorgano-neutralized calcined kaolin is present in a concentration ranging from about 1 to about 100 phr in the product.

23. The product according to claim 15, wherein the product is chosen from cured polymers.

24. The product according to claim 23, wherein the cured polymers are chosen from free radical cured polymers and peroxide cured polymers.

25. A silicone rubber formulation, comprising at least one filler comprising an inorgano-neutralized calcined kaolin, wherein the inorgano-neutralized calcined kaolin comprises calcined kaolin treated with at least one inorganic compound in an amount sufficient to reduce the activity of surface acid sites of the calcined kaolin; and at least one silicone polymer.

26. The silicone rubber formulation according to claim 25, wherein the at least one basic inorganic compound is chosen from ammonium oxalate, sodium carbonate, sodium hydroxide, and trisodium phosphate.

27. The silicone rubber formulation according to claim 25, wherein the at least one basic inorganic compound is in an amount of equal to or greater than about 0.1% by weight of the calcined kaolin in the treatment.

28. The silicone rubber formulation according to claim 27, wherein the at least one basic inorganic compound is in an amount ranging from about 0.1% to about 5.0% by weight of the calcined kaolin in the treatment.

29. The silicone rubber formulation according to claim 28, wherein the at least one basic inorganic compound is in an amount ranging from about 0.5% to about 2.5% by weight of the calcined kaolin in the treatment.

30. The silicone rubber formulation according to claim 29, wherein the at least one basic inorganic compound is in an amount of about 2.0% by weight of the calcined kaolin in the treatment.

31. The silicone rubber formulation according to claim 25, wherein the inorgano-neutralized calcined kaolin is present in a concentration ranging from about 1 to about 200 phr in the silicone rubber formulation.

32. The silicone rubber formulation according to claim 31 wherein the inorgano-neutralized calcined kaolin is present in a concentration ranging from about 1 to about 100 phr in the silicone rubber formulation.

33. A method of making an inorgano-neutralized calcined kaolin, comprising treating calcined kaolin with at least one inorganic compound in an amount sufficient to reduce the activity of surface acid sites of the calcined kaolin, wherein said treating is in an ionizing medium.

34. The method according to claim 33, wherein the ionizing medium is an aqueous medium.

35. The method according to claim 34, wherein the ionizing medium is water.

36. The method according to claim 33, wherein the treating operation comprises forming a slurry with the calcined kaolin and water, and mixing the resulting calcined kaolin slurry with the at least one inorganic compound.

37. The method according to claim 33, wherein the at least one basic inorganic compound is chosen from ammonium oxalate, sodium carbonate, sodium hydroxide, and trisodium phosphate.

38. The method according to claim 33, wherein the at least one basic inorganic compound is in an amount of equal to or greater than about 0.1% by weight of the calcined kaolin in the treatment.

39. The method according to claim 38, wherein the at least one basic inorganic compound is in an amount ranging from about 0.1% to about 5.0% by weight of the calcined kaolin in the treatment.

40. The method according to claim 39, wherein the at least one basic inorganic compound is in an amount ranging from about 0.5% to about 2.5% by weight of the calcined kaolin in the treatment.

41. The method according to claim 40, wherein the at least one basic inorganic compound is in an amount of about 2.0% by weight of the calcined kaolin in the treatment.

42. The method according to claim 33, further comprising drying and pulverizing the calcined kaolin treated with the at least one inorganic compound.

43. A method of making a silicone rubber product, comprising adding into a silicone rubber formulation an inorgano-neutralized calcined kaolin, wherein the silicone rubber formulation comprises at least one silicone polymer and at least one initiator and the inorgano-neutralized calcined kaolin comprises calcined kaolin treated with at least one basic inorganic compound in an amount sufficient to reduce the activity of surface acid sites of the calcined kaolin.

44. The method according to claim 43, wherein the silicone rubber formulation further comprises at least one silica filler.

45. The method according to claim 44, wherein the at least one silica filler is chosen from precipitated silica, crystalline silica, and fumed silica.

46. A method of making a silicone rubber product, comprising adding into a silicone rubber formulation a calcined kaolin and at least one basic inorganic compound in an amount sufficient to reduce the activity of surface acid sites of the calcined kaolin, wherein the silicone rubber formulation comprises at least one silicone polymer and at least one initiator.

47. The method according to claim 46, wherein the silicone rubber formulation further comprises at least one silica filler.

48. The method according to claim 47, wherein the at least one silica filler is chosen from precipitated silica, crystalline silica, and fumed silica.
